(19) United States
(12) Patent Application Publication
(10) Pub. No.: US 2006/0037500 A1
(43) Pub. Date: Feb. 23, 2006

(54) Printing unit and inking unit

(75) Inventor: Gunter Koppelkamm, Neuensalz (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/204,697

(22) Filed: Aug. 16, 2005

(30) Foreign Application Priority Data
Aug. 17, 2004 (DE) 10 2004 039 821.6

(51) Int. Cl. B41L 25/00

(52) U.S. Cl. 101/148

(57) ABSTRACT

A printing unit having at least one press unit, wherein the press unit includes a form cylinder, a transfer cylinder, an inking unit and a damping unit applying damping solution to the form cylinder, wherein a relatively hard chromium-coated ro ceramic-coated roll which picks up the damping solution. According to the present invention, two relatively soft rolls are positioned between the relatively hard chromium-coated or ceramic-coated roll of the damping unit and the forme cylinder and both of the relatively soft rolls are in rolling contact with the forme cylinder and the chromium-coated or ceramic-coated roll. Accordingly, the damping solution picked up by the chromium-coated or ceramic-coated roll is applied directly to the forme cylinder by both relatively soft rolls.

### BACKGROUND OF THE INVENTION

The present invention relates to a printing unit having at least one press unit, wherein the press unit includes a form cylinder, a transfer cylinder, an inking unit and a damping unit applying damping solution to the form cylinder, wherein a relatively hard chromium-coated or ceramic-coated roll which picks up the damping solution. The present invention also relates to a damping unit for a press unit of a press applying damping solution to the form cylinder, wherein a relatively hard chromium-coated or ceramic-coated roll which picks up the damping solution.

Printing units of web-fed rotary presses, in particular of newspaper presses, have a plurality of press units, each of the press units comprising a transfer cylinder, a forme cylinder and an inking unit and also a damping unit. Moreover, such press units may have impression cylinders, an impression cylinder being able to interact with one or more transfer cylinders of different press units. In addition to press units which have impression cylinders of this type, press units are also known which have no impression cylinder, the transfer cylinders of two press units rolling on each other in the case of such printing units without impression cylinders. As a rule, rubber blankets are stretched onto the transfer cylinders and printing plates are clamped onto the forme cylinders, for which reason the transfer cylinders are also designated blanket cylinders and the forme cylinders are also designated printing plate cylinders.

The inking unit of a press unit is used to apply printing ink to the forme cylinder of the press unit and the damping unit is used to apply a damping solution to the forme cylinder of the press unit. The prior art already discloses a series of damping units with which damping solution is applied to a forme cylinder.

For example, FIG. 1 shows a detail from a press unit of a web-fed rotary press in the region of a forme cylinder 10 and a damping unit 11 interacting with the forme cylinder 10. A damping solution is applied to the forme cylinder 10 with the aid of the damping unit 11. This damping unit 11, known from the prior art, has a relatively hard chromium-coated or ceramic-coated roll 12, which picks up damping solution from a damping solution supply 13. According to this prior art, two relatively soft rolls 14 and 15 are arranged between the forme cylinder 10 and the relatively hard chromium-coated or ceramic-coated roll 12. The relatively soft roll 14 is in rolling contact with the forme cylinder 10 and the relatively soft roll 15 is in rolling contact with the relatively hard chromium-coated or ceramic-coated roll 12. Moreover, there is rolling contact between the two relatively soft rolls 14 and 15, so that in the damping unit 11 of FIG. 1, which is known from the prior art, the damping solution is transferred from the relatively hard roll 12 to the relatively soft roll 15, from the relatively soft roll 15 to the relatively soft roll 14, and from the relatively soft roll 14 to the forme cylinder 10. The relatively hard chromium-coated or ceramic-coated roll 12 may be oscillated in an oscillating movement in the axial direction to smooth the damping solution film on the relatively soft roll 15 in rolling contact with the relatively hard roll 12. However, the arrangement of FIG. 1 has the disadvantage that, in the damping unit shown there, the damping solution film on the relatively soft roll 14 in rolling contact with the forme cylinder 10 cannot be smoothed.

To achieve smoothing of the damping solution film on the relatively soft roll 14 in rolling contact with the forme cylinder 10, it is already known from the prior art to position a further relatively hard chromium-coated or ceramic-coated roll between the two relatively soft rolls 14 and 15. Thus, FIG. 2 shows a further damping unit 16 known from the prior art which, in addition to the components already described with reference to FIG. 1, has a further hard chromium-coated or ceramic-coated roll 17 which is in rolling contact with both relatively soft rolls 14 and 15. The second relatively hard roll 17 may also be oscillated in an oscillating movement in the axial direction similarly to the first relatively hard roll 12. Although this solution known from the prior art smooths the damping solution film on the relatively soft roll 14 in rolling contact with the forme cylinder 10, this damping unit 16 known from the prior art has a complicated structure because of the additional relatively hard roll 17. Thus, a drive must be provided for both the relatively hard rolls 12 and 17 for the axial oscillating movement. The damping unit 16 of FIG. 2 is accordingly expensive.

### SUMMARY OF THE INVENTION

It is an object of the present invention to provide a novel printing unit and a novel damping unit which overcomes the problems of the prior art.

The object is met by a printing unit having at least one press unit, wherein the press unit includes a form cylinder, a transfer cylinder, an inking unit and a damping unit applying damping solution to the form cylinder, wherein a relatively hard chromium-coated or ceramic-coated roll picks up the damping solution. According to the present invention, two relatively soft rolls are positioned between the relatively hard chromium-coated or ceramic-coated roll of the damping unit and the forme cylinder and both of the relatively soft rolls are in rolling contact with the forme cylinder and the chromium-coated or ceramic-coated roll. Accordingly, the damping solution picked up by the chromium-coated or ceramic-coated roll is applied directly to the forme cylinder by both relatively soft rolls. Both of the relatively soft rolls form damping solution applicator rolls. The chromium-coated or ceramic-coated roll, which preferably carries out an axial oscillating movement, effects smoothing of the damping solution film on both damping solution applicator rolls.

The object is also met by a damping unit according to the invention for a press unit of a press a damping unit applying damping solution to the form cylinder, wherein a relatively hard chromium-coated or ceramic-coated roll picks up the damping solution. Two relatively soft rolls are positioned between the relatively hard chromium-coated or ceramic-coated roll of the damping unit and the forme cylinder and both of the relatively soft rolls are in rolling contact with the forme cylinder and the chromium-coated or ceramic-coated roll so that the damping solution picked up by the chromium-coated or ceramic-coated roll is applied directly to the forme cylinder by both relatively soft rolls.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a schematic diagram of a portion of a printing unit according to the prior art;

FIG. 2 is a schematic diagram of a further printing unit according to the prior art; and

FIG. 3 is a schematic diagram of a portion of a printing unit according to the present invention.

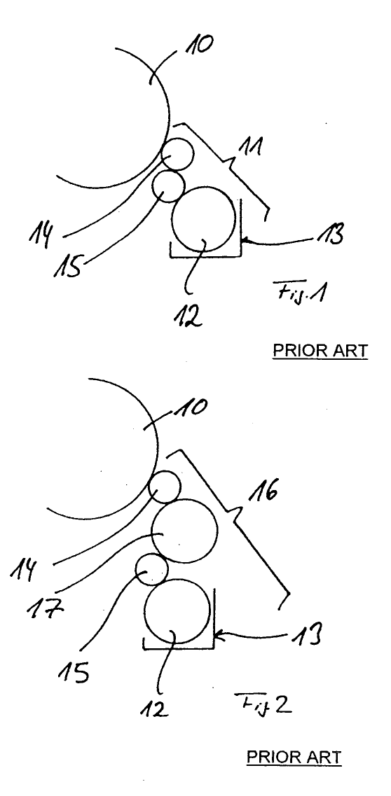

### DETAILED DESCRIPTION OF THE PRESENTLY PREFERRED EMBODIMENTS

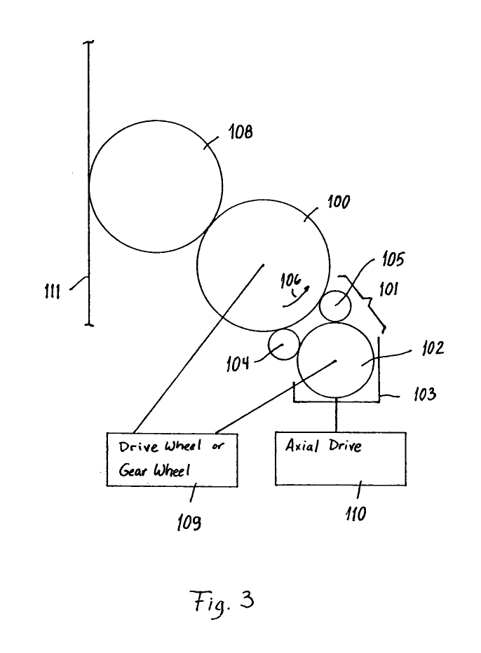

FIG. 3 shows a portion of a printing unit of a web-fed rotary press including a press unit. The press unit shown includes a forme cylinder 100 that interacts with a transfer cylinder 108 for transferring images to a web 111. A damping unit 101 applies a damping solution to the forme cylinder 100.

The damping unit 101 has a relatively hard chromium-coated or ceramic-coated roll 102, which picks up a damping solution from a damping solution supply 103. According to the present invention, two relatively soft rolls 104 and 105 are positioned between the relatively hard chromium-coated or ceramic-coated roll 102 and the forme cylinder 100. Both relatively soft rolls 104 and 105 are in rolling contact with the forme cylinder 100 and with the relatively hard chromium-coated or ceramic-coated roll 102. The damping solution picked up by the relatively hard roll 102 is accordingly applied directly to the forme cylinder 100 by both relatively soft rolls 104 and 105, so that both relatively soft rolls 104 and 105 are designed as damping solution applicator rolls.

According to the present invention, the relatively hard chromium-coated or ceramic-coated roll 102 is oscillated to effect an oscillating movement in the axial direction, so that smoothing of the damping solution film on both relatively soft rolls 104 and 105 is effected by this oscillating movement.

Both relatively soft rolls 104 and 105 of the arrangement according to the invention according to FIG. 3 are in rolling contact and in frictional contact with the forme cylinder 100. Accordingly, the two relatively soft rolls 104 and 105 are driven in rotation by the forme cylinder 100 as a result of this frictional contact. A rotary drive 109 (shown schematically in FIG. 3) of the relatively hard chromium-coated or ceramic-coated roll 102 is provided via a drive wheel or gear wheel, which transmits the rotary movement of the forme cylinder 100 to the relatively hard roll 102. Accordingly, the relatively hard roll 102 is driven in rotation by the forme cylinder 100. In order to provide the oscillating movement in the axial direction, the relatively hard chromium-coated or ceramic-coated roll is assigned a corresponding axial drive 110 for effecting the oscillating movement in the axial direction. The axial drive 110 may be separate from the rotary drive 109 and include a crankshaft drive with a controlled-speed d.c. motor (not shown).

The two relatively soft rolls 104 and 105 are designed as damping solution applicator rolls. In the direction of rotation 106 of the forme cylinder 100, one of the two damping solution applicator rolls (the roll 105 in the exemplary embodiment of FIG. 3) is connected downstream of the other damping solution applicator roll (the damping solution applicator roll 104 in the exemplary embodiment shown in FIG. 3). As viewed in the direction of rotation 106, the damping solution applicator roll 104 accordingly applies damping solution to the forme cylinder 100 first, and then the damping solution applicator roll 105. The configuration according to the present invention has the advantage that the applicator roll 105 connected downstream in the direction of rotation performs smoothing of the damping solution film applied by the applicator roll 104. In this way, the quality of the damping solution application to the forme cylinder 100 is improved.

The solution according to the invention according to FIG. 3 permits uniform application of a damping solution film to a forme cylinder or press unit of a printing unit of a web-fed rotary press with a relatively simple damping unit having only three rolls.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing unit comprising at least one press unit, wherein each press unit includes:
a forme cylinder;
a transfer cylinder arranged for transferring an image from said forme cylinder to a web;
an inking unit applying ink to said forme cylinder; and
a damping unit applying a damping solution to said forme cylinder, said damping unit having a chromium-coated or ceramic-coated roll arranged and dimensioned for picking up damping solution from a damping solution supply, and two relatively soft rolls positioned between said relatively hard chromium-coated or ceramic-coated roll and said forme cylinder, said relatively soft rolls being soft relative to said chromium-coated or ceramic-coated roll, both of said relatively soft rolls being arranged in rolling contact with said forme cylinder and with said chromium-coated or ceramic-coated roll such that the damping solution picked up by said chromium-coated or ceramic-coated roll is applied directly to said forme cylinder by both of said relatively soft rolls.

2. The printing unit of claim 1, wherein said chromium-coated or ceramic-coated roll is arranged for effecting an oscillating movement in the axial direction, smoothing of the damping solution film on both relatively soft rolls being effected by said oscillating movement.

3. The printing unit of claim 1, wherein both of said relatively soft rolls are designed as damping solution applicator rolls and are in frictional contact with said forme cylinder, said relatively soft rolls being driven in rotation by the frictional contact with said forme cylinder.

4. The printing unit of claim 3, wherein a first of said damping solution applicator rolls is connected downstream of a second damping solution applicator roll in a direction of rotation of said forme cylinder, said first damping solution application roll effecting smoothing of the damping solution film applied to said forme cylinder by said second damping solution applicator roll.

5. The printing unit of claim 1, wherein said chromium-coated or ceramic-coated roll is driven by said forme cylinder by a drive wheel or gear wheel.

6. A damping unit for a press unit of a press, said damping unit applying a damping solution to a forme cylinder of the press unit, said the damping unit comprising:
a chromium-coated or ceramic-coated roll arranged and dimensioned for picking up damping solution from a damping solution supply; and
two relatively soft rolls positioned between said relatively hard chromium-coated or ceramic-coated roll and the forme cylinder, said relatively soft rolls being soft relative to said chromium-coated or ceramic-coated roll, both of said relatively soft rolls being arranged in rolling contact with said chromium-coated or ceramic-coated roll and arrangable for rolling contact with the forme cylinder such that the damping solution picked up by said chromium-coated or ceramic-coated roll is applied directly to the forme cylinder by both of said relatively soft rolls when said relatively soft rolls are in rolling contact with the forme cylinder.

7. The damping unit of claim 6, wherein said chromium-coated or ceramic-coated roll is arranged for effecting an oscillating movement in the axial direction, smoothing of the damping solution film on both relatively soft rolls being effected by said oscillating movement.

8. The damping unit of claim 6, both of said relatively soft rolls are designed as damping solution applicator rolls and are arranged for frictional contact with the forme cylinder, said relatively soft rolls being driven in rotation by the frictional contact with the forme cylinder when said damping solution applicator rolls are in frictional contact with the forme cylinder.

9. The damping unit of claim 8, wherein a first of said damping solution applicator rolls is connected downstream of a second damping solution applicator roll in a direction of rotation of said forme cylinder, said first damping solution application roll effecting smoothing of the damping solution film applied to the forme cylinder by said second damping solution applicator roll when the first and second damping solution applicator rolls are in rolling contact with the forme cylinder.

10. The damping unit of claim 6, wherein said chromium-coated or ceramic-coated roll is driven by the forme cylinder by a drive wheel or gear wheel.
